(19) United States
(12) Patent Application Publication
(10) Pub. No.: US 2012/0147063 A1
(43) Pub. Date: Jun. 14, 2012

(54) LIQUID CRYSTAL DISPLAY DEVICE AND METHOD FOR DRIVING THE SAME

(76) Inventors: Tae Wook Lee, Paju-si (KR); Chang Gone Kim, Paju-si (KR)

(21) Appl. No.: 13/302,763

(22) Filed: Nov. 22, 2011

(30) Foreign Application Priority Data
Dec. 8, 2010 (KR) 10-2010-0125108

(51) Int. Cl. G09G 5/10; G09G 3/36; G09G 5/00

(52) U.S. Cl. 345/690; 345/204; 345/88

(57) ABSTRACT

Disclosed is a display device which facilitates to display an image with the same color as an external border (external case) of a liquid crystal display (LCD) device, or to display an image satisfying a user's taste during a no-signal period, and a method for driving the display device, wherein the display device comprises a video controller which outputs interior data in accordance with a preset mode during a no-signal period; a timing controller which arranges the interior data, supplied from the video controller, in a frame unit, and outputs the arranged interior data; a data driver which converts the interior data of the frame unit, supplied from the timing controller, into analog video data, and outputs the analog video data; and a liquid crystal display panel which displays an image by the use of analog video data based on the interior data during the no-signal period.

Pursuant to 35 U.S.C. §119(a), this application claims the benefit of earlier filing date and right of priority to Korean Application 10-2010-0125108 filed on Dec. 8, 2010, the content of which is incorporated by reference herein in its entirety.

### BACKGROUND

1. Field of the Invention

The present disclosure relates to a display device and a method for driving the same, and more particularly, a display device which facilitates to display an image with the same color as an external border (external case) of a liquid crystal display (LCD) device, or to display an image satisfying a user's taste during a no-signal period, and a method for driving the display device.

2. Discussion of the Related Art

According to developments in various mobile electronic equipment, such as mobile terminals and notebook computers, there is increasing demand for an applicable flat panel display device.

The flat panel display device may include a liquid crystal display device (LCD), a plasma display panel (PDP), a field emission display device (FED), an organic light-emitting diode display device (OLED), and etc.

Among the flat display devices, the LCD device has been generally used owing to various advantages such as highly-developed technology for mass production, easy operation method, low power consumption, thin profile, high resolution, and large-sized screen.

The LCD device displays images by controlling light transmittance pixel-by-pixel in accordance with an input video signal. For this, the LCD device comprises a liquid crystal display panel with a plurality of pixels arranged in a matrix configuration; a backlight unit for supplying light to the liquid crystal display panel; and a driving circuit for driving the liquid crystal display panel and the backlight unit.

An electric field is formed in the pixel by common voltage and data voltage (pixel voltage) supplied to the pixel, and a transmittance of light emitted from the backlight unit is controlled by an alignment of liquid crystal through the electric field

FIGS. 1 and 2 illustrate a screen displayed on a liquid crystal display panel of a related art LCD device during a no-signal period.

Referring to FIG. 1, the related art LCD device displays a black image during a no-signal period, that is, when a video signal is not supplied or it is a power-off state. That is, during the no-signal period, video data is not supplied to the related art LCD device, whereby the black image is displayed on the liquid crystal display panel 10.

Recently, a design of the LCD device as well as its function has been emphasized for satisfying a user's aesthetic desire. When the black image is displayed on the liquid crystal display panel 10 during the no-signal period, there may be a color difference between the displayed black image and an external border (or case) of the LCD device, whereby the user may be unsatisfied with this color difference

Referring to FIG. 2, the related art LCD device displays particular-colored image on the liquid crystal display panel 10 by the use of video data preset in a timing controller (T-con) during the no-signal period, to thereby prevent the black image from being displayed on the liquid crystal display panel 10 during the no-signal period.

For example, a red image, green image, blue image, and white image may be displayed in rotation on the liquid crystal display panel 10.

However, if the color of the image displayed on the liquid crystal display panel 10 shown in FIG. 2 is different from the color of the external border (or case) of the LCD device, it is difficult to sufficiently satisfy the user's aesthetic desire.

A particular-colored film, for example, white-colored film may be applied so as to enhance an interior function of the LCD device during the no-signal period. In this case, a manufacturing cost may be increased due to the additional use of the particular-colored film.

### BRIEF SUMMARY

An LCD device comprises: a video controller, which outputs interior data in accordance with a preset mode during a no-signal period; a timing controller, which arranges the interior data supplied from the video controller, in a frame unit, and outputs the arranged interior data; a data driver, which converts the interior data of the frame unit supplied from the timing controller, into analog video data, and outputs the analog video data; and a liquid crystal display panel, which displays an image by the use of analog video data based on the interior data during the no-signal period.

In another aspect of the present invention, there is provided a method for driving an LCD device comprising displaying an image on a liquid crystal display panel by the use of video data supplied from the external, wherein particular-colored or particular-patterned image is displayed on the liquid crystal display panel by the use of preset interior data during a no-signal period

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 and 2 illustrate a screen displayed on a liquid crystal display panel of a related art LCD device during a no-signal period;

FIG. 3 illustrates an LCD device according to the embodiment of the present invention;

FIG. 4 illustrates a video controller shown in FIG. 3; and

FIGS. 5 to 7 illustrate a method for driving an LCD device according to the embodiment of the present invention.

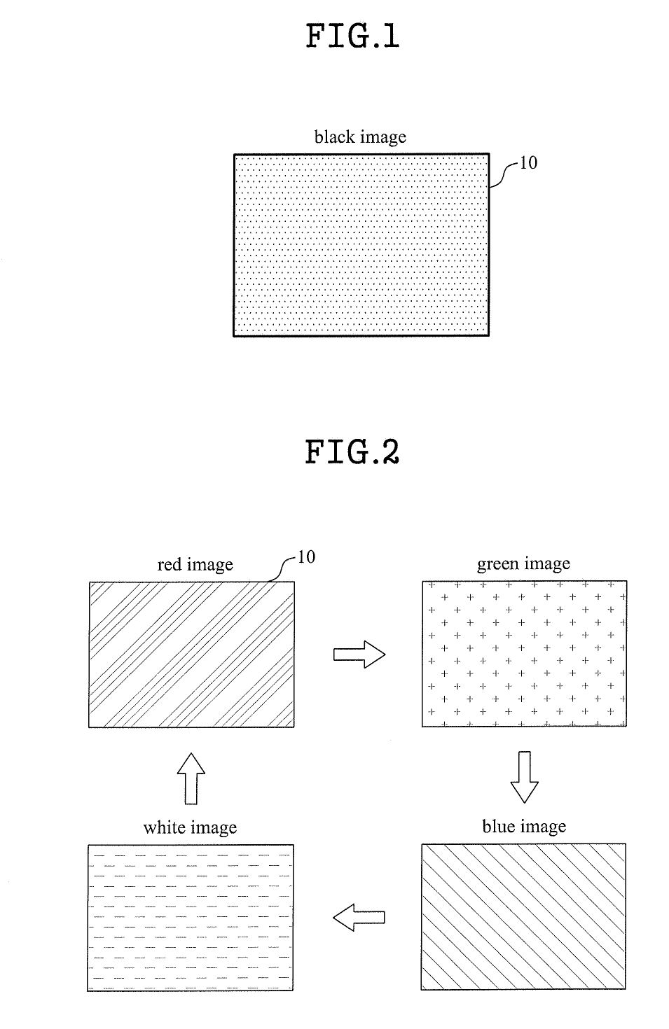

### DETAILED DESCRIPTION OF THE DRAWINGS AND THE PRESENTLY PREFERRED EMBODIMENTS

Reference will now be made in detail to the exemplary embodiments of the present invention, examples of which are illustrated in the accompanying drawings. Wherever possible, the same reference numbers will be used throughout the drawings to refer to the same or like parts.

In case of an LCD device according to the present invention and a method for driving the same, even though a video signal is not supplied to the LCD device, or the LCD device is turned-off by a user, a preset image satisfying a user's taste is displayed on a liquid crystal display panel, which enables to satisfy a user's aesthetic desire, and to enhance an interior function of the LCD device.

Hereinafter, a display device according to the present invention and a method for driving the same will be described with reference to the accompanying drawings.

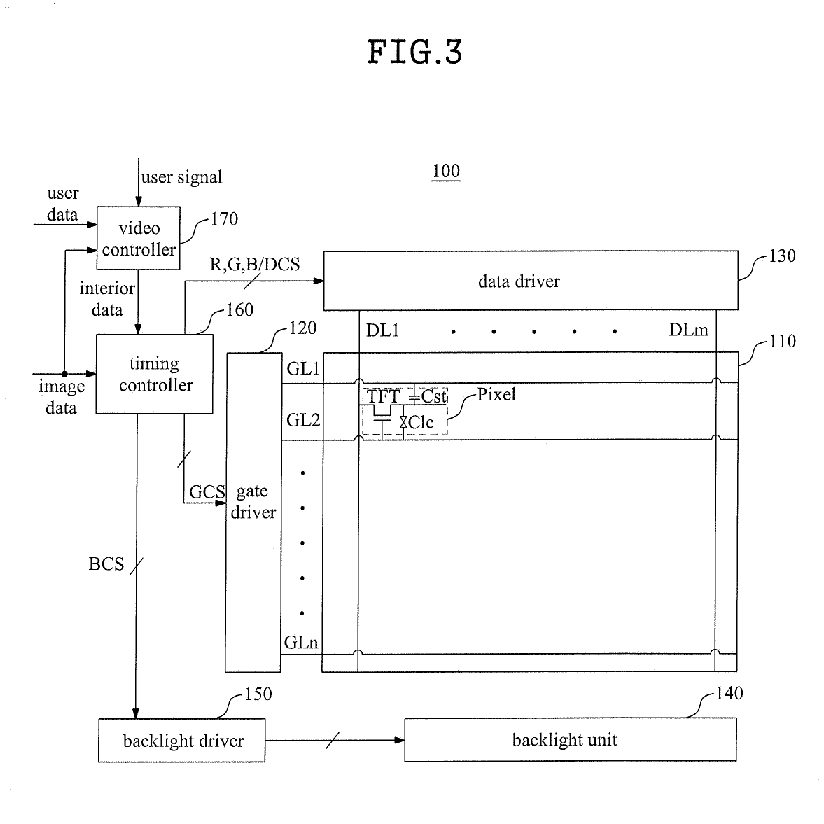

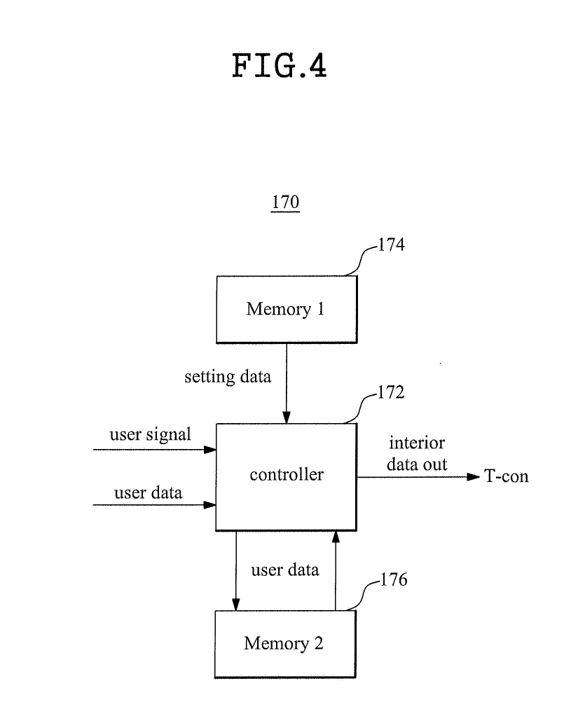

FIG. 3 illustrates an LCD device according to the embodiment of the present invention. FIG. 4 illustrates a video controller shown in FIG. 3.

Referring to FIG. 3, the LCD device 100 according to the embodiment of the present invention comprises a liquid crystal display panel 110 which displays an image in accordance with video data; a backlight unit 140 which supplies light to the liquid crystal display panel 110; a video controller 170 which enables to display a preset image during a no-signal period; and a driving circuit which drives the liquid crystal display panel 110.

The liquid crystal display panel 110 comprises lower and upper substrates bonded to each other with a liquid crystal layer interposed therebetween. Also, a plurality of pixels for displaying the image may be arranged as a matrix configuration in the liquid crystal display panel 110.

On the upper substrate, there are a black matrix which defines a pixel region corresponding to each pixel; and red, green and blue color filters which are formed in the respective pixel regions defined by the black matrix.

On the lower substrate, there are gate lines (GL1˜GLn) and data lines (DL1˜DLm), wherein each pixel is defined by the gate and data lines crossing each other.

Each of the pixels comprises a thin film transistor (TFT) and storage capacitor (Cst) which are formed adjacent to the crossing portion of the gate and data lines. A gate terminal of the thin film transistor (TFT) is connected with the gate line; a source terminal thereof is connected with the data line; and a drain terminal thereof is connected with a pixel electrode.

A common electrode is formed on the upper substrate or lower substrate. Depending on a switching of the thin film transistor (TFT), a data voltage (video data) is supplied to the pixel electrode, and a common voltage (Vcom) is supplied to a common electrode.

Liquid crystal of the pixel is driven by an electric field which is formed by the data voltage and common voltage.

The backlight unit 140 supplies light to the liquid crystal display panel 110, wherein the backlight unit 140 comprises a plurality of backlights and optical members.

The optical members may comprise a light-guiding plate, light-diffusion plate, reflective sheet, light-diffusion sheet, and prism sheet. These optical members guide the light emitted from the backlight unit 140 toward the liquid crystal display panel 110, and improves efficiency of the light applied to the liquid crystal display panel 110.

The plurality of backlights may be CCFLs (Cold Cathode Fluorescent Lamp) or LEDs (Light-Emitting Diode).

At this time, a backlight driver (inverter/LED driver) 150 controls on-off time and dimming state in the plurality of backlights.

The backlight driver 150 drives the plurality of backlights in accordance with a backlight control signal (BCS) transmitted from a timing controller 160. At this time, the backlight driver 150 controls duty rate and dimming level of the backlight so that the image is displayed on the liquid crystal display panel 110 while being maintained with good quality.

The driving circuit may comprise a gate driver 120, data driver 130, and timing controller (T-CON) 160.

The timing controller 160 receives video data (image data) from the external; converts the received video data into digital video data (R, G, B) in a frame unit; and supplies the digital video data to the data driver 130. Also, the timing controller 160 supplies interior data supplied from the video controller 170 to the data driver 130.

At this time, the interior data indicates video data preset by a user, which is to be supplied to the data driver 130 during the no-signal period, and then to be displayed on the liquid crystal display panel 110. That is, the interior data is provided to display the preset image during the period when the video data inputted from the external is not displayed on the liquid crystal display panel 110.

Also, the timing controller 160 generates a gate control signal (GCS) for controlling the gate driver 120, and a data control signal (DCS) for controlling the data driver 130 by the use of vertical/horizontal synchronous signal (Vsync/Hsync) and clock signals (CLK). The generated gate control signal (GCS) is supplied to the gate driver 120, and the generated data control signal (DCS) is supplied to the data driver 130.

At this time, the gate control signal (GCS) may include a gate start pulse (GSP), a gate shift clock (GSC), and a gate output enable (GOE).

The data control signal (DCS) may include a source start pulse (SSP), a source sampling clock (SSC), a source output enable (SOE), and a polarity control signal (POL).

Also, the timing controller 160 generates a backlight control signal (BCS) for controlling the on-off time and dimming level of the plurality of backlights; and supplies the generated backlight control signal (BCS) to the backlight driver 150.

The gate driver 120 generates a scan signal for driving the thin film transistor (TFT) in each pixel on the basis of the gate control signal (GCS) supplied from the timing controller 160. The generated scan signal is sequentially supplied to the plurality of gate lines.

The data driver 130 converts the digital video data or interior data supplied from the timing controller 160 into an analog data voltage. On the basis of the data control signal (DCS) supplied from the timing controller 160, the data voltage is supplied to the plurality of data lines at the timing of turning-on the thin film transistor (TFT) in each pixel.

During the no-signal period, the video controller 170 supplies the video data set based on the user's taste or the video data additionally set by the user, that is, interior data to the timing controller 160.

At this time, the video controller 170 may sense no-signal by detecting the video data from the external; or may receive information about no-signal from the timing controller 160.

During the no-signal period, the timing controller 160 supplies the interior data from the video controller 170 to the data driver 130. Instead of a black image or rotation image (red image, green image, blue image, white image), the desire image set based on the user's taste is displayed on the liquid crystal display panel 110 during the no-signal period, thereby enabling to satisfy the user's aesthetic desire, and to enhance the interior function of the LCD device.

A user signal is inputted to the video controller 170 by the use of select menu prepared in the external of the LCD device 100 or prepared in a radio control device (remove controller), whereby the user selects the interior image to be displayed on the liquid crystal display panel 110.

As shown in FIG. 4, the video controller 170 comprises a controller 172, a first memory 174, and a second memory 176. At this time, the first memory 174 and second memory 176 may be realized by non-volatile memory devices such as EEPROM.

During the no-signal period, the controller 172 loads the image to be displayed on the liquid crystal display panel 110, that is, interior data into the first memory 174 or second memory 176 in accordance with the user signal. The interior data loaded into the first memory 174 or second memory 176 is supplied to the timing controller 160.

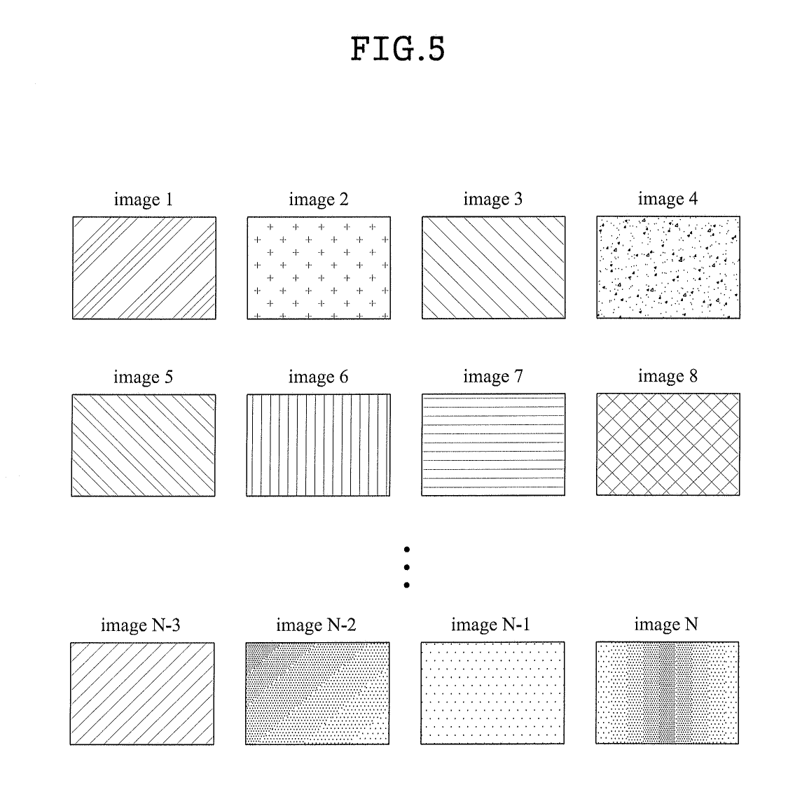

As shown in FIG. 5, the preset ‘N’ video data may be stored as the first interior data in the first memory 174. At this time, the first interior data may include the particular-colored video data or particular-patterned video data.

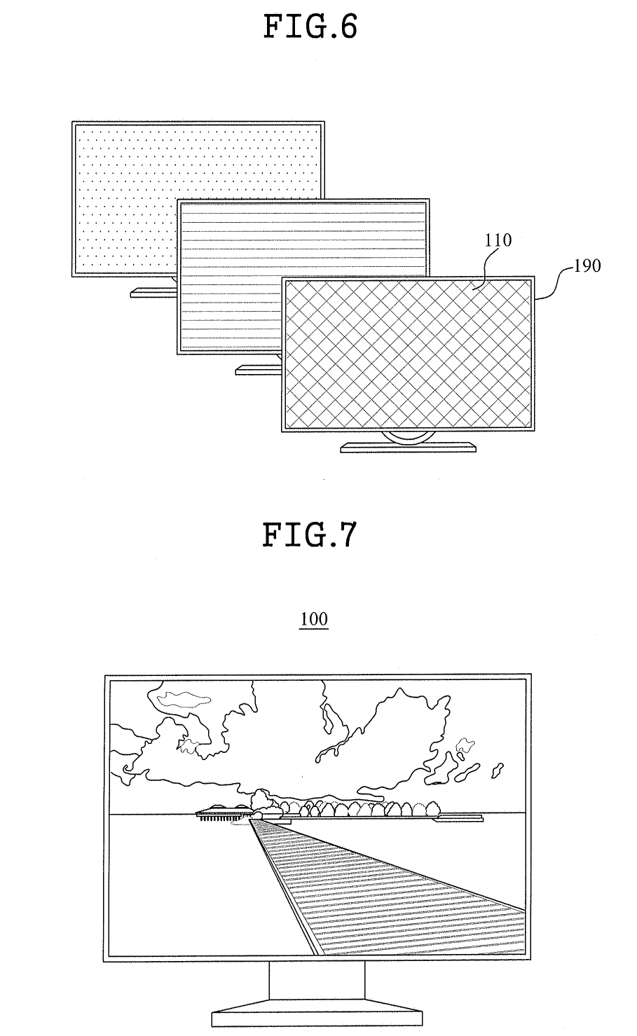

As shown in FIG. 6, the user may select the image whose color is the same as the external border (external case) 190 of the LCD device from the first interior data, whereby the image whose color is the same as the external border 190 may be displayed on the liquid crystal display panel 110 during the no-signal period.

Also, the user may select the image which is similar to the surroundings of the LCD device 100, or is in harmony with the surroundings of the LCD device 100, whereby the image being similar to the surroundings of the LCD device 100 or being in harmony with the surroundings of the LCD device 100 may be displayed on the liquid crystal display panel 110 during the no-signal period.

The controller 172 may store data inputted by the user, that is, user data in the second memory 176.

At this time, the user data indicates second interior data desirous of being displayed on the liquid crystal display panel 110 during the no-signal period. The second interior data may be inputted into the second memory via an additionally-prepared input means (USB terminal, wireless input means).

Referring to FIG. 7, the user may store the second interior data, for example, landscape image or family photograph, in the second memory 176.

During the no-signal period, the video controller 170 supplies the second interior data stored in the second memory 176 to the timing controller 160. The timing controller 160 supplies the second interior data to the data driver 130. Thus, the image based on the second interior data may be displayed on the liquid crystal display panel 110 during the no-signal period.

The first interior data stored in the first memory 174, or the second interior data stored in the second memory 176 may be freely changed based on the user's selection.

During the no-signal period, only one image may be displayed, or the plurality of images may be displayed in a rotation method or slide-show method to enhance the interior function.

For this, the controller 172 may set an output option of the timing controller 160 in accordance with the user signal, and display the option image on the liquid crystal display panel 110 during the no-signal period.

For example, the black image may be displayed on the liquid crystal display panel 110 by setting a RBF pin option of the timing controller 160 as ‘00’.

Also, the red (R), green(G), blue(B), and white(W) images may be displayed in the rotation method by setting RBF pin option of the timing controller 160 as ‘01’.

In another example, if the RBF pin option of the timing controller 160 is set as ‘10’, the image based on the first interior data stored in the first memory may be displayed on the liquid crystal display panel 110.

If the RBF pin option of the timing controller 160 is set as ‘11’, the image based on the second interior data stored in the second memory may be displayed on the liquid crystal display panel 110.

In case of the LCD device according to the present invention and the method for driving the same, the image whose color is the same as the external border of the LCD device, or the image preset based on the user's taste is displayed on the liquid crystal display panel 110 during the no-signal period, to thereby satisfy the user's aesthetic desire, and to enhance the interior function of the LCD device.

For the above explanation, the video controller 170 is individually provided inside the LCD device 100, but not necessarily. According to another embodiment of the present invention, the video controller 170 may be provided inside the timing controller 160.

For the above explanation, the first and second memories 174 and 176 are included in the video controller 170, and the first memory 174 is separately provided from the second memory 176, but not necessarily. According to another embodiment of the present invention, the first and second memories 174 and 176 may be integrated into one memory.

The above embodiment of the present invention is applied to the LCD device among the various flat display devices, but not necessarily. The present invention may be applied to the various flat display devices as well as the LCD device.

Accordingly, the LCD device of the present invention is capable of realizing the enhanced interior function owing to the interior image set by the user's taste and displayed on the liquid crystal display panel during the no-signal period, to thereby satisfy the user's aesthetic desire.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An LCD device comprising:
a video controller, which outputs interior data in accordance with a preset mode during a no-signal period;
a timing controller, which arranges the interior data supplied from the video controller, in a frame unit, and outputs the arranged interior data;
a data driver, which converts the interior data of the frame unit supplied from the timing controller, into analog video data, and outputs the analog video data; and
a liquid crystal display panel, which displays an image by the use of analog video data based on the interior data during the no-signal period.

2. The LCD device according to claim 1, wherein the video controller outputs the interior data enabling to display the image whose color is the same as an external border of the LCD device on the liquid crystal display panel in accordance with the preset mode inputted by a user during the no-signal period.

3. The LCD device according to claim 1, wherein the video controller outputs the interior data enabling the other-colored images except the black image on the liquid crystal display panel in accordance with the preset item inputted by the user during the no-signal period.

4. The LCD device according to claim 1, wherein the video controller stores user video data inputted by the user, and outputs the user video data as the interior data during the no-signal period.

5. The LCD device according to claim 1, wherein the video controller comprises:
a first memory in which particular-colored or particular-patterned video data is stored; and
a second memory in which the user video data inputted by the user is stored.

6. A method for driving an LCD device comprising displaying an image on a liquid crystal display panel by the use of video data supplied from the external,
wherein a particular-colored or a particular-patterned image is displayed on the liquid crystal display panel by the use of preset interior data during a no-signal period

7. The method according to claim 6, further comprising:
displaying an interior image whose color is the same as an external border of the LCD device in accordance with a preset mode during the no-signal period.

8. The method according to claim 6, further comprising:
displaying other-colored images except a black image on the liquid crystal display panel in accordance with a preset mode during the no-signal period.

9. The method according to claim 6, further comprising:
storing user video data inputted by a user, and displaying an interior image based on the user video data on the liquid crystal display panel during the no-signal period.

10. The method according to claim 9, wherein the particular-colored image, particular-patterned image and user image are displayed on the liquid crystal display panel by a rotation method.
